(19) United States
(12) Patent Application Publication
(10) Pub. No.: US 2008/0170074 A1
(43) Pub. Date: Jul. 17, 2008

(54) Method For Generating a Map Depiction For Optimal Perceptibility of Streets to Travel Through

(75) Inventor: Wolfgang Beier, Weil der Stadt (DE)

Correspondence Address: PATENT CENTRAL LLC;Stephan A. Pendorf, 1401 Hollywood Boulevard, Hollywood, FL, 33020, US

(73) Assignee: Daimler AG, Stuttgart (DE)

(21) Appl. No.: 12/064,189

(22) PCT Filed: Aug. 15, 2006
(86) PCT No.: PCT/EP2006/008035

§ 371 Date: Feb. 19, 2008

(30) Foreign Application Priority Data
Aug. 19, 2005 (DE) 10 2005 039 581.3

(51) Int. Cl. G01C 21/32; G08G 1/0969

(52) U.S. Cl. 345/442

(57) ABSTRACT

The invention relates to a method for generating a map depiction displaying street courses to travel through, for example in navigation, toll ticketing depiction or in precision applications such as automatic driving. For this purpose a street course consists of stringing together geometrical elements, for example, one or several circle arcs or one or several straight lines, wherein clothoids connect circle arcs and/or straight lines without sharp bends. The clothoids are calculated according to a required resolution from the arc of circle elements approximately approached by values or simply omitted, thereby making it possible to obtain a map depiction particularly reliably and optimal in terms of memory allocations.

The invention concerns a method for producing street maps which can in turn be used as a data set, for example for navigation purposes or for use in conjunction with automatic toll collection systems.

The determination, as to whether a street contained in the data set is being traveled by a vehicle, initially occurs by measuring the position or, as the case may be, movement of the vehicle and subsequently comparing the obtained sensor values with the map data. Therein it is necessary, for a rapid response of the system, that the number of sensors be as few as possible and that the amount of data necessary for the map representation be a small as possible, to that a substantially error-free decision can be made as to whether a particular street is actually being traveled or not.

In presently existing digital street map representations the course of a street is represented in the form of polygonal segments. In this type of representation the correspondence with the true course of the actual street is improved as the spacing of the support or interpolation points becomes closer, which interpolation points are then connected with straight lines. The disadvantage of this mode of representation is obviously that, for a precise as possible reproduction of vacillating streets, the number of the interpolation points must increase in the same measure, and therewith also the amount of data.

A further disadvantage of this type of street representation or display is that, in an application in which it must be determined by measurements whether a vehicle is traveling a particular street, it is necessary to make a comparison of the actual sensor values with the stored polygonal segments. However, the measurement results which are available in the vehicle describe positions, direction of travel, distances, and in certain cases changes in direction of the vehicle negotiating curves. Only the position of the support point in the map representation of the street can directly correlate with the obtained sensor values—the straight lines lying in-between in the polygonal segments represent neither the traveled and measured direction, nor the real curvature of the street. Since the exclusive reliance on the support points does not provide a sufficient solution, it is necessary with this type of street representation that a transformation of the elements of the data set into the elements of the measurement sensors occurs, which is disadvantageous for a rapid and precise evaluation.

Other processes for reducing the amount of data and nevertheless maintaining good recognition qualities are known from street toll detection systems. Here, for example, the characteristics of a street course or track are reduced to particular features and measurable characteristics. Thus, for example, the direction of travel and the tolerances to reference points are detected in specified intervals, or changes in direction of travel are evaluated within a tolerance circle (again as polygon segments). The thus obtained data are condensed for example in a Boolean decision chain, which in certain cases are associated with other previously recognized characteristics of this type. Such processes also in principal solve the problem of recognizing the street of travel, but are however not optimal in their utilization of information provided by the sensor values.

The present invention begins where the above-discussed state of the art leaves off. It is concerned with the task of developing a process for generating street maps in which, with a comparatively smaller data amount, the stored street map depiction follows the actual course very precisely.

In a process of the type set forth in the precharacterizing portion of claim 1, this task is solved by the characteristics of the characterizing portion of claim 1. Further advantages and preferred embodiments of the inventive process are set forth in the dependent claims.

The inventive process produces map data, wherein a street course is comprised of a sequence of sequentially oriented geometric elements, wherein arcs, straight lines and clothoids are employed as the geometric elements, depending upon the resolution. For this, a small number of parameters are sufficient in order to reproduce an actual street course with high precision. For this, the same data can be employed which is supplied as measurement values by the conventional sensors, so that transformation error can be avoided. By a continuous representation the processing algorithm requires a small computation power of the vehicle device, smoothly distributed over time.

The inventive process is explained in the following on the basis of preferred embodiments with reference to the figures and the therein reproduced reference numbers. There is shown in:

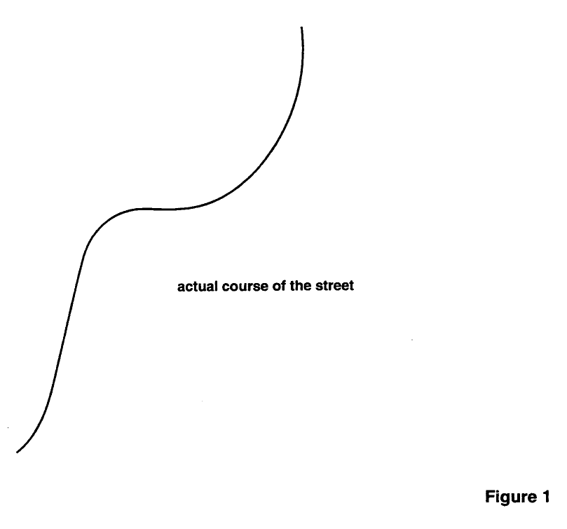

FIG. 1 the course of the street with curves to be depicted or displayed,

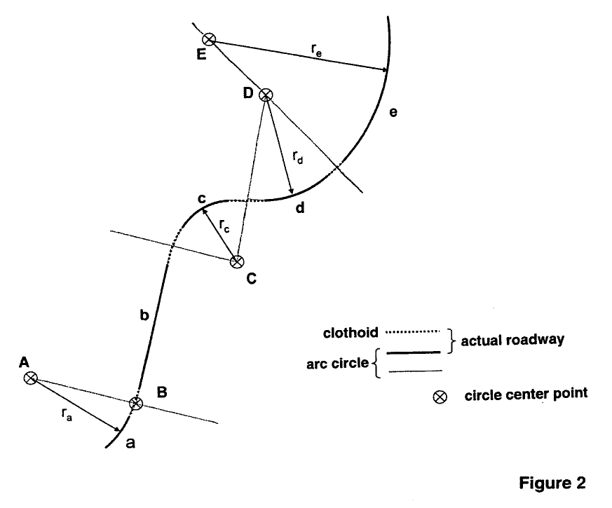

FIG. 2 dissecting the course of the street into circle arcs, straight lines and clothoids,

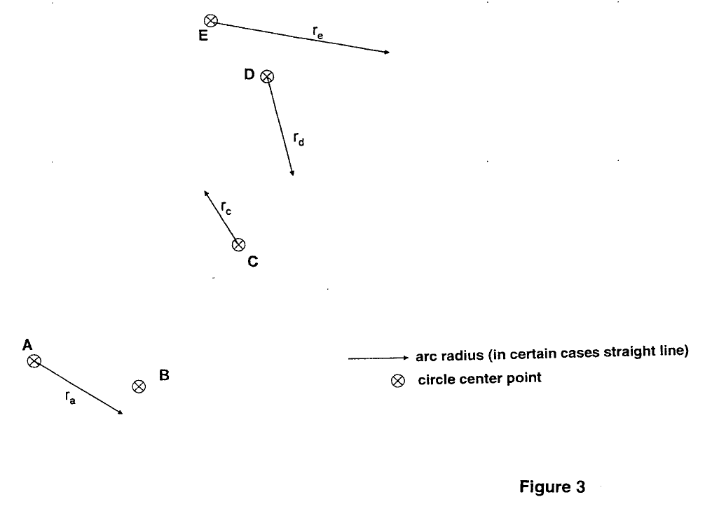

FIG. 3 elements for reproduction of the course of the street via circle arcs,

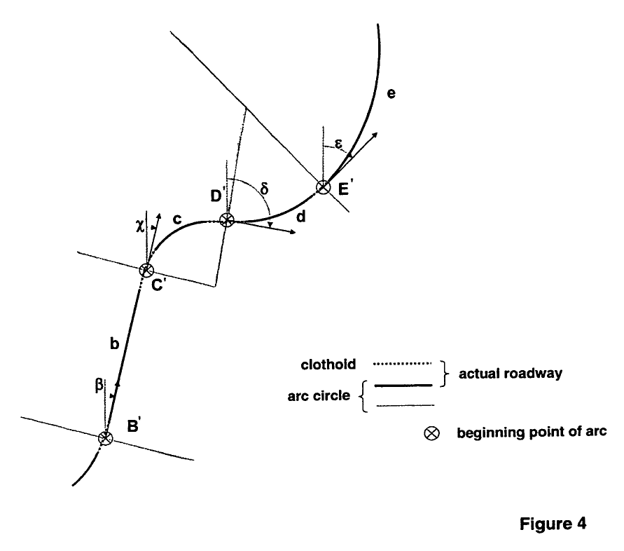

FIG. 4 division of the course of the street into data regarding direction changes,

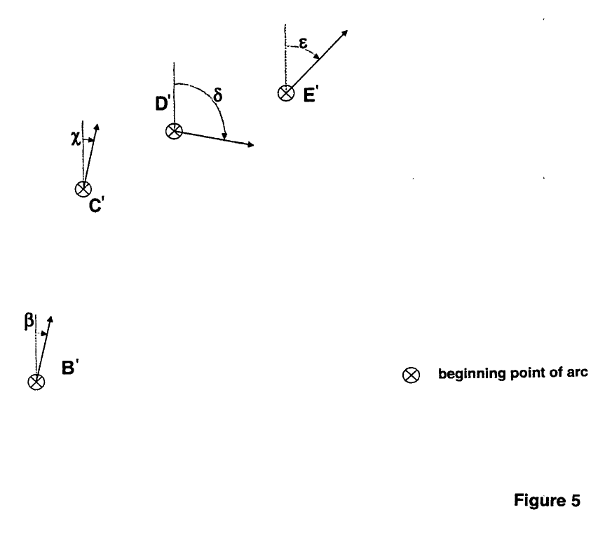

FIG. 5 elements for reproduction of the course of the street via direction changes, and

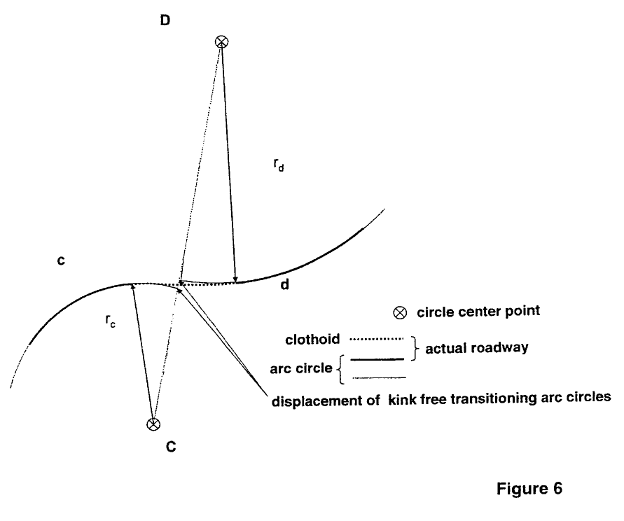

FIG. 6 transition area between two arcs.

The invention takes into consideration that streets are constructed today according to specific guidelines, so that driving is as simple and thus as safe as possible. As criteria it is therein of significance, that the simplest matter of driving for following the course of a street involves alternately resting and turning of the steering wheel with constant speed. That means, a driver either keeps the steering wheel steady, thus drives along an arc (a straight line viewed in this way is merely a special form of an arc)—or he moves the steering wheel with a constant speed and therewith drives along a clothoid (spiral). The change-over time should therein be such that the duration of driving along a clothoid should be approximately 2-3 seconds. If this includes a directional change, for example from a right curve with direct transition to a left curve, this time should be approximately 4 seconds.

According to these guidelines street courses thus are comprised of alternating of arcs and clothoids, wherein the clothoids are so designed, that they can be transitioned with normal speed in 2-4 seconds. The clothoids are therein mostly approximated by simplistic mathematical approximations, such as for example by cubic parabola. If one takes these construction guidelines for the course of streets into consideration for generating a street map, then the best form of description is also the use of precisely these elements, that is, the use of arc segments and the transitions there-between. As explained above, the parameter of a transition is however predefined with very narrow tolerances, so that in the description of a course of a street this can be presumed in many cases or applications to even be constant, and then need not be expressly quantified, which further reduces the required data set and computation complexity.

If one compares in practical examples how far tracks using clothoids and tracks which simply extend or elongate the circle arcs until they are the same direction, then one can determine that there is only a few meter of deviation. From this, one can conclude that, for example for applications in the navigation or in the autonomic street toll detection systems the form of the transitions can even be disregarded. In other applications, for example, the automatic piloting, automatic snow removal vehicles or the like—depending upon the degree of precision required—either estimated transition courses are sufficient or, in certain cases, actual individually determined transition courses are required. One can, as described later, derive assumptions from the parameters which describe the sequentially following circle arcs, with the aid of which assumptions the intermediate lying clothoids can be precisely defined.

In practice it thus depends upon the application, whether a vehicle onboard device precisely defines the transition between arcs, or approximates by rigid predetermined shapes or, if these can be completely dispensed with, by simply extending arcs and connecting these to each other.

One substantial advantage of the inventive process is that the amount of data which his required in order to define the course of the street as precisely as possible can be kept small. By the proposed description of the course of the street using arcs, straight lines (as special arcs) and clothoids the amount of data is not (or hardly) dependent upon the precision of the description of the course of the street—nor from the length of the street or the size of the direction changes. The required data amount is however determined by the number of changes in curvature, that is, the number of the arc segments, and therewith by the parameters required to describe an arc.

In principal an arc has two translational degrees of freedom, one rotational and respectively one degree of freedom in the magnitude and in the direction of change. This would be, for one single arc, five parameters in order to describe it. The number of degrees of freedom however become reduced, since the arcs may not be oriented independent of each other. One degree of freedom—the direction of start—is produced or results from the final direction of the preceding arc or bow, since the arc or bow must transition to each other along the same direction. Therewith one translational degree of freedom need not be explicitly stated, since it likewise is produced from the end of the preceding bow. If clothoid transitions can be disregarded in the description, which then if required no longer allows an estimation or approximation, then even the second translational degree of freedom already results from the preceding bow.

If the second translational degree of freedom is described for applications with particular requirements for precision, and therewith the reconstruction of the clothoid is enabled, then three values remain for each of the arcs in a sequence. As to in which display these degrees of freedom can be optimally defined, this depends upon the therefrom derived requirements asked of the computer power in the evaluation. In principal the display of the degrees of freedom and the sensors in a vehicle should correspond to the greatest extent possible. Thus for example in use of directional sensors or, as the case may be, directional change sensors (gyroscopes) then directions; in the case of use of absolute position determination, then in this case point coordinates and connecting lines should be used. The calculation of a curvature requires a certain amount of computation power during the evaluation, which power can be saved, if this curvature is used as the manner of display of an arc. Then one would have as the display of the three degrees of freedom an arc in a string without kinks of the starting coordinates (for example length and degree of latitude) and the curvature thereof.

In FIG. 1 it is presumed that this is an example of a generic street course that is comprised of variously curved segments. These should serve as reference for various proposals for the notation of the three variables per description element.

In FIG. 2 the course of this street is analyzed in a display, which is optimal as a result of sensor measurement when using only position coordinates. Here the arc bow segments (a, c, d, e) are defined via the respective arc center points (A, C, D, E) and the radials (rₐ, r_{c}, r_{d}, rₑ), which allows a simple comparison with the position coordinates. The actual lateral buffer, which the vehicle has relative to the course of the street, is produced in this example for each point in time from the comparison between the sum of the squares (quadrates) of the coordinate differences (north and east differences) and the square of the actual arc radius r (Pythagoras). A transition from one arc into the next always occurs when the relationship of the north and east difference of the arc bow center point corresponds to the relationship of the north and east difference of the own position and one of the center points.

A special case is the straight segment (b) between the arc bow a and c. This segment can be onto the circle arc a or estimated simply as a circle arc with the radius “0” and the center point B. Therewith the direction of travel remains unchanged until reaching the next circle arc segment c. The therefrom resulting parameters, which must be cumulatively archived over the course of the street according to FIG. 1, are represented in FIG. 3 (without the course of the street itself).

If one employs direction of travel measuring sensors, for example, gyroscopes or wheel sensors, which identify a change in direction, then another form of analysis of the course of the street and its degrees of freedom is more advantageous. In FIG. 4 the description of the course of the street is reproduced via parameters, which are suitable for the use with position and direction as sensor information. A comparison with the measurements in the vehicle results here, in that (beginning with the start direction “north”) proceeding from a starting position (B′, C′, D′, E′) the changes ( [symbol] X, δ, ε) of the directions of the street are extrapolated. The direction of change for each path segment is therein produced from the separation to the start of the next bow and from the difference of the respective approach directions. If the clothoid is disregarded as the transition between the arcs, the result is a small kink in the transition from one arc into the next (see FIG. 6).

This manner of display of the street and the measurements makes possible a clearly more precise comparison than with pure position values, since the precision of a course curve is substantially higher than that in the case of a position measurement. FIG. 5 shows the therefrom solved parameters for description of the course of the street in this manner.

The clothoid as transition is as described above either disregarded or can be calculated from the progression of the arcs determined with three parameters. In FIG. 6 it is clear how in the display of arcs (c, d) by their center points (C, D) and their radials (r_{c}, r_{d}) the clothoids in-between can be precisely determined. From the separation of the center points and the sum of the two radials the lateral displacement of the arcs can be easily computed. Therewith, for the clothoid to be determined, the start radius, the end radius and the lateral displacement of the arc are known, if one extrapolates these into a knick-free transition. A clothoid is however only determined by three parameters—the start and end radius as well as the change of the center point angle per path segment. Therewith a rapid change of the center point angle of a path segment (rapid rotation of the steering wheel) results in a small displacement of the bow end, or as the case may be, a slow change of the center point angle per path segment results in a larger displacement. From this one can conclude that a predetermined displacement can only be depicted by a single clothoid. If appropriate clothoids are stored for various displacement values, then the course reproduction between the arcs is simplified in that respectively individual exact computations need not be carried out, but rather simple associated (standard) clothoids can be stored.

Depending on the type and the coverage of the employed measurement sensor there results, as described above, a different optimal notation of the three degrees of freedom for each circle arc, which all precisely represent the course of the street, which however required varying amounts of computation power during the application. Since however an ideal map display should optimally support all manner of use of sensors, from the above-described possibilities those must be selected which make possible both the simplest sensor evaluation with particularly low computation power, as well as the evaluation with a more diverse combination of sensors with greater computation power. From these considerations, there results the set of parameters of FIG. 3, that is, the center point coordinates of the arc segments and their radials, as a particularly convenient or suitable form of representation. From this one can compute the coordinates of the circle arc beginning, their initial direction, their curvature and their end points with relative ease, from which, together with the parameters of the next bow, the clothoid can be determined (in the case this is necessary for a particular application). Various possibilities could be considered for the mathematic derivation necessary therefore.

The inventive process thus offers the possibility of a broad range of applications: depending upon the employed sensors, all necessary reference values for the respective measurement values can be very precisely determined—and that in such a form that for the simplest applications the computation is particularly simple, however, also for complex requirements and sensor combinations with greater computation complexity all desired data can be provided. All manner of applications produce thereby a better likelihood of comparison between street course display and all available measurement values than in the case of street maps in a conventional display, and at the same time the requirement for storage capacity remains small.

1. A process for generating a map display with the courses of streets for use, for example, in navigation, street toll detection or in precision applications such as automatic driving, wherein a course of a street is mapped by a sequence of sequentially arranged geometric elements, wherein as geometric elements circle arcs (a, c, d, e), straight segments (b) and, for applications with higher locational resolution, clothoids are employed.

2. The process for generation of a map display according to claim 1, wherein the circle arc is described with at least three parameters, such as for example coordinates of the center point (A, B, C, D), radius (rₐ, r_{c}, r_{d}, rₑ,), start and end point of the circle arc, arc curve length (a, c, d, e), initial direction, magnitude of direction change (β, X, δ, ε).

3. The process for generation of a map display according to claim 1, wherein a straight segment (b) is described by a particular display, for example as arc with a radius designation of “0”, of which the arc center point (B) is defined as the start of the straight segment.

4. The process according to claim 1, wherein clothoids are approximately reproduced via approximation shapes, for example cubic parabola.

5. The process according to claim 1, wherein for display of the course of the street clothoids are mapped as transition between sequential arcs.

6. The process according to claim 5, wherein the clothoids are computed from parameters of the circle arcs to be joined.

7. The process according to claim 5, wherein the clothoids are computed from the offset of sequential circle arcs.

8. The process according to claim 5, wherein for different offset areas or ranges, predetermined clothoids are stored as data sets and are called up for display of the course of the street.
